(19) United States
(12) Patent Application Publication
(10) Pub. No.: US 2009/0309864 A1
(43) Pub. Date: Dec. 17, 2009

(54) PLASMA DISPLAY DEVICE AND PLASMA DISPLAY PANEL DRIVE METHOD

(76) Inventors: Takayuki Kobayashi, Miyazaki (JP); Tomokatsu Kishi, Miyazaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/298,324

(22) PCT Filed: Jul. 14, 2006
(86) PCT No.: PCT/JP2006/314075

§ 371 Date: Feb. 20, 2009

(51) Int. Cl. G06F 3/038; G09G 3/28

(52) U.S. Cl. 345/213; 345/60

(57) ABSTRACT

A first driving circuit alternately reverses polarities of voltages applied to a first and a second electrode in order to cause sustain discharge between the first and second electrodes. A second driving circuit applies a pulse to a fourth electrode in synchronization with a timing when the Polarities of the voltages to the first and second electrodes are reversed. Further, during the sustain discharge, the second driving circuit keeps a voltage of the fourth electrode after the application of the pulse, at an offset voltage deviated by a Predetermined value from an initial voltage that the fourth electrode has before the generation of the pulse, and thereafter returns the voltage of the fourth electrode to the initial voltage. For example, the offset voltage is set to a value between a high-level voltage and a low-level voltage applied to the first and second electrodes. Consequently, luminescent efficiency can be improved.

### CROSS REFERENCE TO RELATED APPLICATION

This application is a U.S. National Stage application claiming the benefit of prior filed International Application Number PCT/JP2006/314075, filed Jul. 14, 2006.

### TECHNICAL FIELD

The present invention relates to a plasma display device and a method of driving a plasma display panel.

### BACKGROUND ART

A plasma display panel is constituted by bonding two glass plates to each other and displays an image by generating discharge light to a space formed between the glass plates. Recently, there has been proposed a plasma display panel in which Z electrodes are each disposed between an X electrode and a Y electrode between which the sustain discharge is produced (see, for example, a patent document 1). Generally, with an increase in the distance between the X electrodes and the Y electrodes, luminescent efficiency becomes higher but a firing voltage (voltage difference between the X electrodes and the Y electrodes) becomes higher as well. With the Z electrodes disposed, it is possible to increase the distance between the X electrodes and the Y electrodes to improve luminescent efficiency without causing an increase in the firing voltage.

Patent Document 1: Japanese Unexamined Patent Application Publication No. 2000-110047

### DISCLOSURE

### Problems to be Solved

However, if not only avalanche (pre-discharge process) but also discharge (short-distance discharge) occurs between the Z electrodes and the X electrodes (or the Y electrodes) during the sustain discharge, wall charges in the X electrodes (or the Y electrodes) reduce. If this causes insufficient discharge between the X and Y electrodes (long-distance discharge), luminescent efficiency may not be sufficiently improved.

It is a proposition of the present invention to improve luminescent efficiency of a plasma display panel.

### Means for Solving the Problems

In the present invention, a first driving circuit alternately reverses polarities of voltages applied to a first and a second electrode in order to cause sustain discharge between the first and second electrodes. A second driving circuit applies a pulse to a fourth electrode in synchronization with a timing at which the polarities of the voltages to the first and second electrodes are reversed. During the sustain discharge after the application of the pulse, the second driving circuit keeps a voltage of the fourth electrode at an offset voltage deviated by a predetermined value from an initial voltage that the fourth electrode has before the generation of the pulse, and thereafter returns the voltage of the fourth electrode to the initial voltage. For example, the offset voltage is set to a value between a high-level voltage and a low-level voltage applied to the first and second electrodes. Consequently, an amount of wall charges stored in the fourth electrode during the sustain discharge can be reduced, which makes the involvement of the fourth electrode in the discharge difficult. As a result, it is possible to increase a ratio of high-efficiency long-distance discharge between the first and second electrodes, which can improve luminescent efficiency.

### EFFECT

In the present invention, it is possible to increase a ratio of high-efficiency long-distance discharge between a first and a second electrode, which can improve luminescent efficiency.

### BRIEF DESCRIPTION OF THE DRAWINGS

FIG. 1 is a block diagram illustrating an outline of a plasma display device in a first embodiment.

FIG. 2 is an exploded perspective view illustrating details of an essential part of a PDP illustrated in FIG. 1.

FIG. 3 is a plane view illustrating details of a front plate illustrated in FIG. 2.

FIG. 4 is an explanatory chart illustrating an example of the structure of a field for displaying an image of a screen.

FIG. 5 is a waveform chart illustrating an outline of a sustain period illustrated in FIG. 4.

FIG. 6 is a circuit diagram illustrating details of a Z driver illustrated in FIG. 1.

FIG. 7 is a circuit diagram illustrating another example of the Z driver illustrated in FIG. 1.

FIG. 8 is a waveform chart illustrating operations in the sustain period in the PDP of the first embodiment.

FIG. 9 is a waveform chart illustrating operations in a sustain period in a PDP studied by the present inventors.

FIG. 10 is a circuit diagram illustrating details of a Z driver in a second embodiment of the present invention.

FIG. 11 is a circuit diagram illustrating another example of the Z driver in the second embodiment.

FIG. 12 is a waveform chart illustrating operations in a sustain period in a PDP of the second embodiment.

FIG. 13 is a circuit diagram illustrating details of a Z driver in a third embodiment of the present invention.

FIG. 14 is a circuit diagram illustrating another example of the Z driver in the third embodiment.

FIG. 15 is a waveform chart illustrating operations in a sustain period in a PDP of the third embodiment.

FIG. 16 is a circuit diagram illustrating details of a Z driver in a fourth embodiment of the present invention.

FIG. 17 is a circuit diagram illustrating another example of the Z driver in the fourth embodiment.

FIG. 18 is a waveform chart illustrating operations in a sustain period in a PDP of the fourth embodiment.

### DETAILED DESCRIPTION OF THE EMBODIMENTS

Hereinafter, embodiments of the present invention will be described by using the drawings.

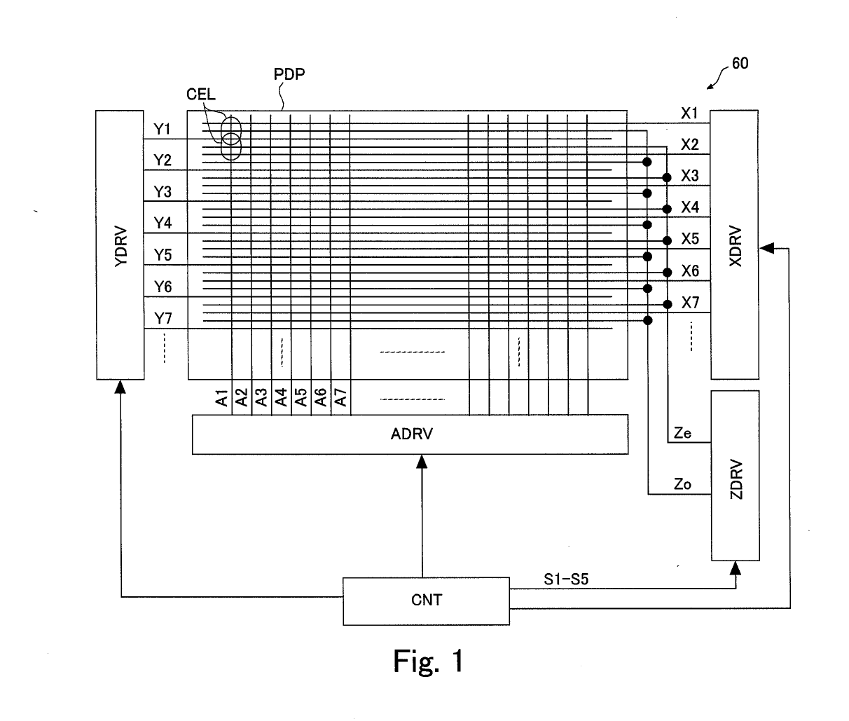

FIG. 1 illustrates an outline of a plasma display device (hereinafter, referred to as a PDP device) in a first embodiment of the present invention. The PDP device has a plasma display panel PDP, an X driver XDRV, a Y driver YDRV, a Z driver ZDRV, an address driver ADRV, a control circuit CNT controlling the operations of the drivers XDRV, YDRV, ZDRV, ADRV, a not-shown power-supply circuit, and so on.

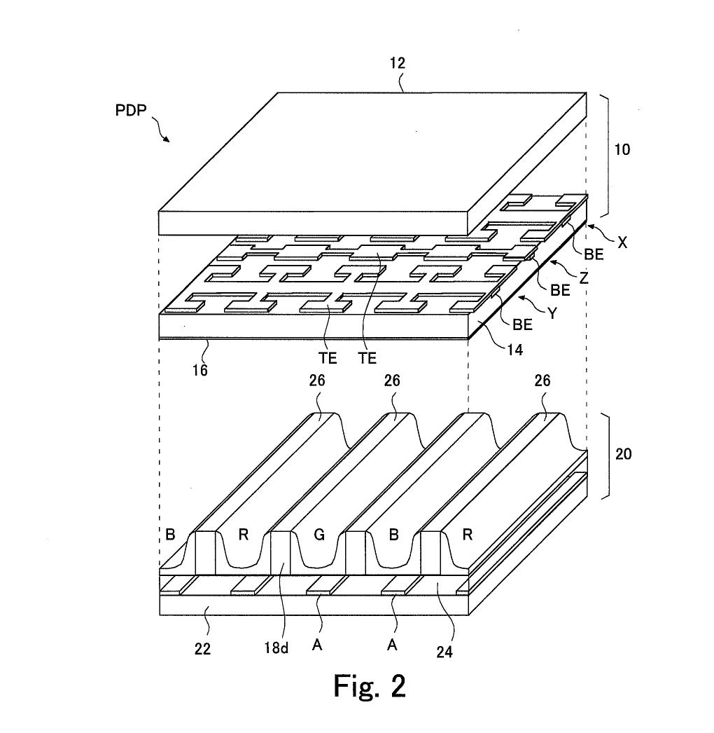

The plasma display panel PDP has a plurality of X electrodes X1, X2, X3, . . . (first electrodes), Y electrodes Y1, Y2, Y3, . . . (second electrodes) each disposed between the X electrodes, Z electrodes Ze, Zo (fourth electrodes) each disposed between the X electrode and the Y electrode, and address electrodes A1, A2, . . . (third electrodes; hereinafter also referred to as A electrodes) disposed in a direction perpendicular to the X electrodes, the Y electrodes, and the Z electrodes. The X electrodes, the Y electrodes, and the Z electrodes are formed on a front plate (first plate) and the A electrodes are formed on a back plate (second plate). A cross-sectional structure of the PDP will be described in FIG. 2.

Display cells CEL are formed at positions where the X electrodes, the Y electrodes, and the Z electrodes intersect with the A electrodes. Discharge gaps for emitting light by the discharge are provided on both sides of the X electrodes and the Y electrodes. Therefore, the cells adjacent in the up/down direction in FIG. 1 party overlap with each other. In order to display a color image on the PDP, one pixel is made up of a cell CEL emitting red light, a cell CEL emitting green light, and a cell CEL emitting blue light.

In the PDP of this type, even-numbered discharge lines and odd-numbered discharge lines extending in a lateral direction in FIG. 1 alternately emit light. This method is called an ALIS method (Alternate Lighting of Surfaces Method). Since the discharge by the even-numbered lines and the discharge by the odd-numbered lines are alternated, the Z electrodes Zo for the odd-numbered lines and the Z electrodes Ze for the even-numbered lines are alternately disposed. Concretely, each of the Z electrodes Zo is disposed between the X electrode and the Y electrode whose tail numbers are the same. Each of the Z electrodes Ze is disposed between the X electrode and the Y electrode whose tail numbers are different by one (for example, X3 and Y2).

The X driver XDRV and the Y driver YDRV operate as a first driving circuit applying predetermined voltages to the X electrodes and the Y electrodes. The Z driver ZDRV operates as a second driving circuit applying a predetermined voltage to the Z electrodes. The Z driver ZDRV operates in response to switch control signals S1-S5 from the control circuit CNT. The address driver ADRV operates as a third driving circuit applying a predetermined voltage (selection pulse) to the A electrode in order to select a display cell which is to emit light by the discharge.

FIG. 2 illustrates details of an essential part of the PDP illustrated in FIG. 1. The front plate 10 has the X electrodes and the Y electrodes alternately formed in parallel to each other on a glass base 12 (the lower side in FIG. 2). Each of the Z electrodes is disposed between the X electrode and the Y electrode. The X electrodes and the Y electrodes are each made up of a bus electrode BE extending in the lateral direction in FIG. 2 and a transparent electrode TE formed along the bus electrode BE. Each of the Z electrodes is made up of a bus electrode BE and a transparent electrode TE formed along the bus electrode BE. The X electrodes, the Y electrodes, and the Z electrodes are covered by a dielectric layer 14, and a surface of the dielectric layer 14 is covered by a protective layer 16 of MgO or the like.

The back plate 20 has the address electrodes A formed in parallel to one another on a glass base 22. The address electrodes A are disposed in a direction perpendicular to the bus electrodes BE. The address electrodes A are covered by a dielectric layer 24. On the dielectric layer 24, barrier ribs (ribs) 26 are formed at positions between the adjacent address electrodes A. On side surfaces of the barrier ribs 26 and on the dielectric layer 24 between the adjacent barrier ribs 26, phosphors R, G, B emitting red, green, and blue visible lights when excited by ultraviolet rays are applied.

The PDP 10 is formed in such a manner that the front plate 10 and the back plate 20 are bonded so that the protective layer 16 and the barrier ribs 26 are in contact with each other, and discharge gas such as Ne or Xe is enclosed therein. The bus electrodes BE and the address electrodes A extend up to an end portion, of the PDP, positioned on an outer side of a seal area formed in an outer peripheral portion of the PDP, and are each coupled to one of the drivers XDRV, YDRV, ZDRV, ADRV.

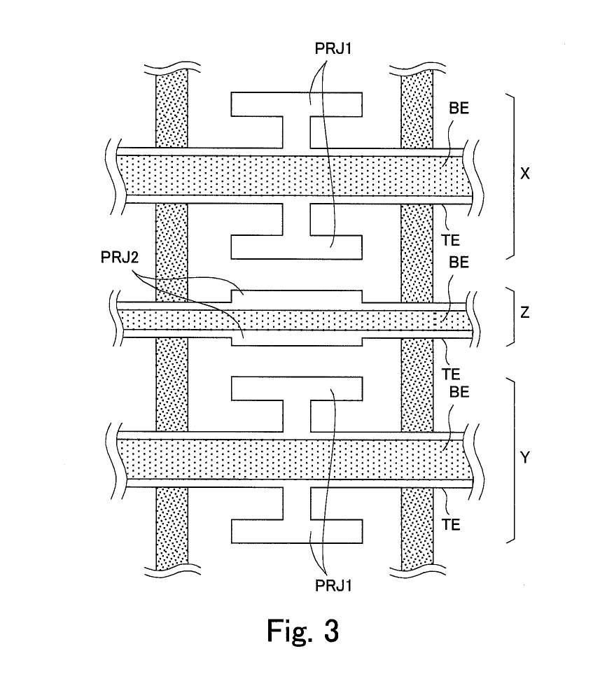

FIG. 3 illustrates details of the front plate 20 illustrated in FIG. 2. The X electrodes and the Y electrodes have the same shape, and the transparent electrodes TE thereof have projection parts PRJ1 projecting in the direction perpendicular to the bus electrodes BE and each having a narrowed center portion. Each of the Z electrodes has a projection part PRJ2 projecting toward the projection parts PRJ1 of the X electrode and the Y electrode positioned on both sides. Incidentally, each of the Z electrodes may include only the transparent electrode TE or only the bus electrode BE.

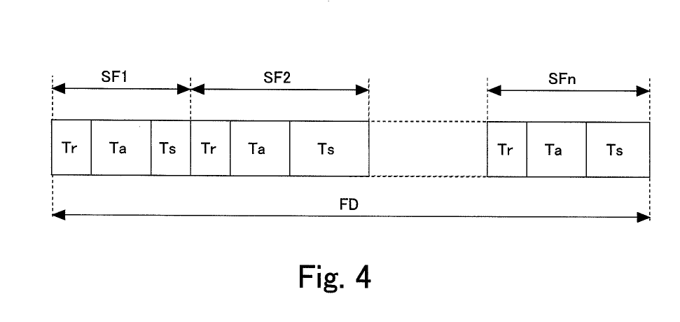

FIG. 4 illustrates an example of the structure of a field FD for displaying an image of one screen. One field FD has a length of, for example, 1/60 second and is made up of n subfields SF (SF1, SF2, . . . , SFn). Each of the subfields SF has a reset period TR, an address period Ta, and a sustain period TS.

For example, in the reset period Tr, a negative write voltage is applied to the X electrodes and a positive write voltage which gently increases (write dull wave) is applied to the Y electrodes. Consequently, positive and negative wall charges are stored in the X electrodes and the Y electrodes respectively while the light emission of the cells is suppressed. Here, the wall charges are, for example, plus charges and minus charges stored on the MgO layer 16 illustrated in FIG. 2 in the cells CEL. Next, a positive adjusting voltage is applied to the X electrodes and a negative adjusting voltage (adjusting dull wave) is applied to the Y electrodes. Consequently, an amount of the wall charges is reduced and all the cells CEL are initialized to have an equal amount of the wall charges.

In the address period Ta, a positive scan voltage is applied to the X electrodes, a negative scan pulse is applied to the Y electrodes, and a positive address pulse is applied to the electrode A corresponding to the cell CEL which is to be lighted. The cell selected by the address pulse starts discharging.

In the sustain period Ts, negative and positive sustain pulses are applied to the X electrodes and the Y electrodes respectively. Further, in synchronization with transition edges of the sustain pulses, a trigger pulse is applied to the Z electrodes. By this operation, the discharge state of the lighted cell is maintained. Thereafter, the discharge pulses opposite in polarity and the trigger pulse are repeatedly applied to the X electrodes, the Y electrodes, and the Z electrodes, so that the discharge of the lighted cell is repeated in the sustain period Ts.

The lengths of the reset period Tr and the address period Ta are constantly the same independently of the subfields SF. The length of the sustain period Ts differs among the subfieds SF and depends on the number of times the discharge of the cell is repeated (luminance). Therefore, by changing the combination of the subfields SF for the lighting, the gradation expression becomes possible.

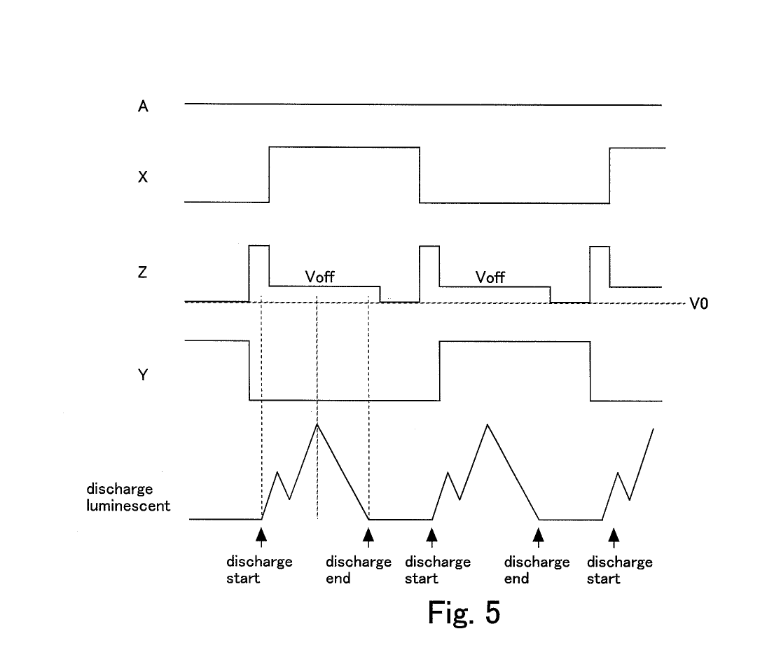

FIG. 5 illustrates an outline of the sustain period Ts illustrated in FIG. 4. In the sustain period Ts, for example, voltages opposite in polarity are applied to the X electrodes and the Y electrodes so that high-level voltage periods thereof do not overlap with each other. That is, the polarities of the voltages applied to the X electrodes and the Y electrodes are alternately reversed. Further, in synchronization with the timing at which the polarities of the voltages to the X electrodes and the Y electrodes are reversed, a positive pulse is applied to the Z electrodes. The width of the pulse applied to the Z electrodes is 100-1000 ns. When a voltage difference between the Z electrodes and the X electrodes (or the Y electrodes) becomes equal to or larger than a firing voltage due to the pulse to the Z electrodes, the discharge is started (trigger discharge). Triggered by the trigger discharge, sustain discharge occurs between the X electrodes and the Y electrodes. Then, the trigger discharge and the sustain discharge are repeated, so that each of the cells CEL emits light with a predetermined luminance. While the sustain discharge is underway between the X and Y electrodes (for example, the display lines where the Zo electrodes extend), the Z electrodes between the X and Y electrodes with no sustain discharge therebetween (for example, the Ze electrodes) are fixed to, for example, ground voltage GND and function as barrier electrodes suppressing the interference between the cells CEL emitting light by the discharge.

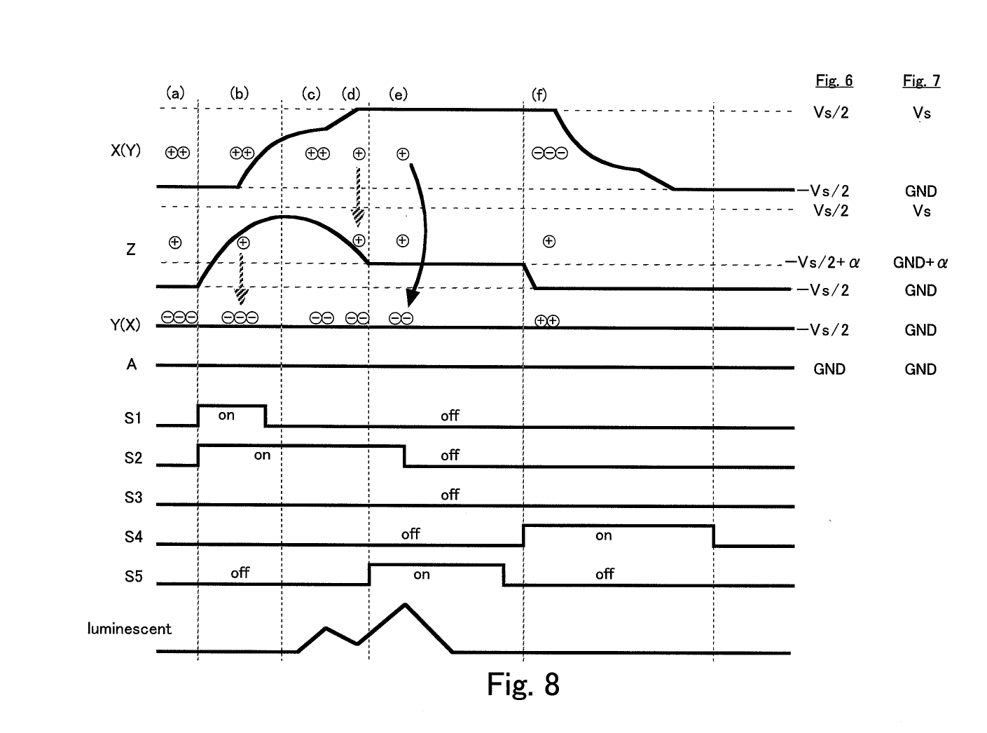

Further, in the present invention, during the sustain discharge between the X electrodes and the Y electrodes, the voltage of the Z electrodes after the application of the positive pulse is kept at an offset voltage Voff which is deviated by a predetermined value from an initial voltage V0 that the Z electrodes have before the generation of the positive pulse, and after the sustain discharge is finished, the voltage of the Z electrodes is returned to the initial voltage V0. This can reduce a voltage difference between the X electrodes (or the Y electrodes) with the high-level voltage and the Z electrodes and can prevent the wall charges stored in the X electrodes (or the Y electrodes) from moving between these electrodes to the Z electrodes. Therefore, high-efficiency long-distance discharge between the X electrodes and the Y electrodes can occur. Details of the discharge during the sustain period Ts will be described in FIG. 8.

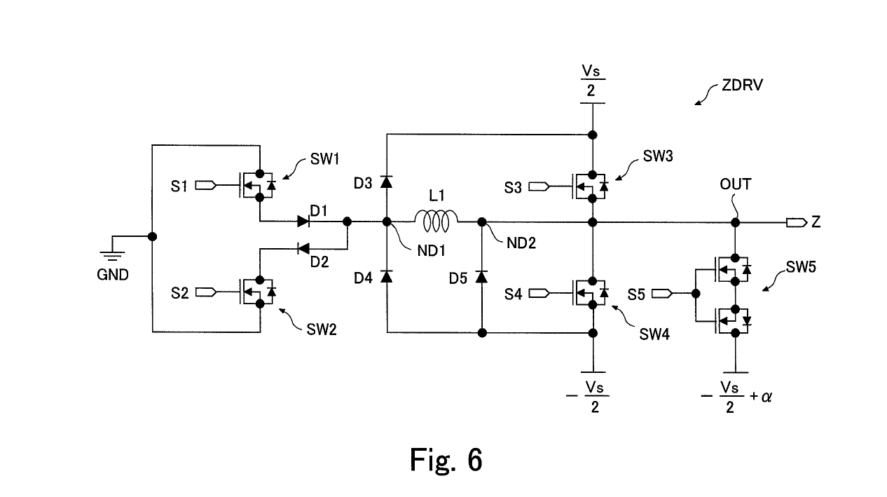

FIG. 6 illustrates details of the Z driver ZDRV illustrated in FIG. 1. The Z driver ZDRV has a coil L1, switching circuits SW1, SW2, SW3, SW4, SW5, and diodes D1, D2, D3, D4, D5. The coil L1 and the switching circuits SW1, SW2, SW3, SW4 operate as a resonance circuit for generating a resonance pulse to the Z electrodes. Each of the switching circuits SW1-4 is made up of an nMOS transistor. The switching circuit SW5 is made up of a pair of serially coupled nMOS transistors. Each of the nMOS transistors has a diode coupling a source and a drain. The switching circuits SW1-5 receive the switch control signals S1-5 respectively at gates thereof. The switching circuits SW1-5 turn on when the switch control signals S1-5 have high logic level and turn off when the switch control signals S1-5 have low logic level.

A drain of the switching circuit SW1 and a source of the switching circuit SW2 are coupled to a ground line GND. A source of the switching circuit SW1 is coupled to a node ND1 which is one end of the coil L1, via the forward-coupled diode D1. A drain of the switching circuit SW2 is coupled to the node ND1 via the backward-coupled diode D2. The node ND1 is coupled to power sources Vs/2, −Vs/2 via the backward-coupled diodes D3, D4 respectively. The switching circuit SW3 has a drain coupled to the power source Vs/2 and a source coupled to a node ND2 which is the other end of the coil L1. The switching circuit SW4 has a source coupled to the power source −Vs/2 (initial voltage line) and a drain coupled to the node ND2. The diode D5 is forward-coupled between the power source −Vs/2 and the node ND2. The switching circuit SW5 is coupled between an output node OUT of the Z driver ZDRV and a power source −Vs/2+α (offset voltage line). The output node OUT is coupled to the node ND2 and the Z electrodes (Zo or Ze).

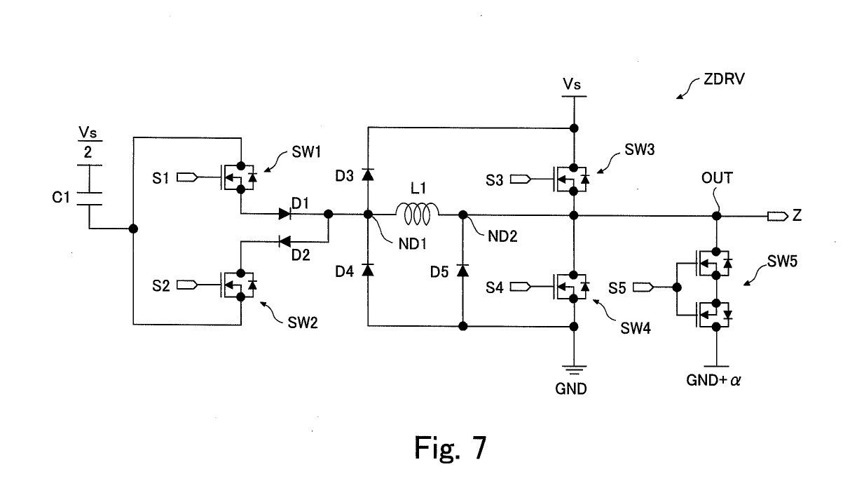

FIG. 7 illustrates another example of the Z driver ZDRV illustrated in FIG. 1. Its difference from the Z driver ZDRV illustrated in FIG. 6 lies in that the drain of the switching circuit SW1 and the source of the switching circuit SW2 are coupled to the power source Vs/2 via a capacitor C1. Further, the drain of the switching circuit SW3 is coupled to a power source Vs, the source of the switching circuit SW4 is coupled to the ground line GND (initial voltage line), and the source of the switching circuit SW5 is coupled to a power source GND+α (offset voltage line). The other structure is the same as that in FIG. 6.

FIG. 8 illustrates operations in the sustain period Ts in the PDP of the first embodiment. The waveforms in FIG. 8 are those in the period, illustrated in FIG. 5, when the positive pulse is applied to the X electrodes. In the Z driver ZDRV illustrated in FIG. 6, a high-level voltage of the Z electrodes is slightly lower than Vs/2 and a low-level voltage (initial voltage) of the Z electrodes is −Vs/2. In the Z driver ZDRV illustrated in FIG. 7, the high-level voltage of the Z electrodes is slightly lower than Vs and the low-level voltage (initial voltage) of the Z electrodes is GND. The Z drivers ZDRV illustrated in FIG. 6 and FIG. 7 are different only in voltage amplitude. Therefore, the operation of the Z driver ZDRV illustrated in FIG. 6 will be described in the following description. Note that the X driver XDRV and the Y driver YDRV have the structure of the Z driver ZDRV from which the switching circuit SW5 is removed, for instance.

First, by the latest sustain discharge, positive wall charges are stored in the X electrodes and the Z electrodes and negative wall charges are stored in the Y electrodes (FIG. 8(a)). At this time, an amount of the wall charges stored in the Z electrodes is relatively small. The voltages of the X electrodes, the Z electrodes, and the Y electrodes are set to −Vs/2.

Next, the switch control signals S1, S2 change to the high logic level, so that the switching circuits 1, 2 turn on. By the rectifying operation of the diodes D1, D2, current flows only in the diode D1, and by the resonance operation of the coil L1, the voltage of the Z electrodes increases (FIG. 8(b)). Since an amount of the wall charges in the Z electrodes is small, the discharge (trigger discharge) occurring between the Z electrodes and the Y electrodes is relatively weak and this is a state immediately before the discharge occurs (avalanche). Therefore, an amount of the wall charges moving between the Z electrodes and the Y electrodes is relatively small (the dashed arrow).

Next, the X driver XDRV operates to increase the voltage of the X electrodes (FIG. 8(c)). By the resonance operation of the coil L1, the voltage of the Z electrodes decreases after increasing almost to the maximum voltage Vs/2. Since the voltage of the X electrodes increases and the voltage of the Z electrodes decreases, a voltage difference between the X electrodes and the Z electrodes gradually becomes larger (FIG. 8(d)). Before the voltage of the Z electrodes decreases to −Vs/2, the switch control signal S5 changes to the high logic level to turn on the switching circuit SW5. While the switching circuit SW5 is on, the voltage of the Z electrodes is kept at the offset voltage which is higher than −Vs/2 by α. That is, the switching circuit SW5 couples the Z electrodes to the power source −Vs/2+α in synchronization with the timing at which a trailing edge of the resonance pulse is generated. Therefore, the voltage difference between the X electrodes and the Z electrodes becomes smaller than Vs and the discharge between the X electrodes and the Z electrodes (short-distance discharge) is relatively low (the dashed arrow).

Next, an output node of the X driver XDRV is clamped at the voltage Vs/2 and the voltage of the X electrodes increases to Vs/2 (FIG. 8(e)). Since the short-distance discharge between the X electrodes and the Z electrodes is relatively weak as described above, a ratio of the high-efficiency discharge (long-distance discharge) between the X electrodes and the Y electrodes increases. Further, since the voltage of the Z electrodes is kept at −Vs/2+α, an amount of the wall charges stored in the Z electrodes is smaller than that when the voltage of the Z electrodes is decreased to −Vs/2.

After the long-distance discharge between the X electrodes and the Y electrodes is finished, the switch control signal S5 changes to the low logic level to turn off the switching circuit SW5. Further, the switch control signal S4 changes to the high logic level to turn on the switching circuit SW4. Since the switching circuit SW4 turns on, the voltage of the Z electrodes decreases to the initial voltage −VS/2 (FIG. 8(f)). By the long-distance discharge between the X electrodes and the Y electrodes, negative wall charges are stored in the X electrodes and positive wall charges are stored in the Y electrodes. Thereafter, the sustain discharge is caused in the same manner as in the above-described (a) to (f). However, since the polarities of the wall charges stored in the X electrodes and the Y electrodes become reversed, it is necessary to read the X electrodes as Y electrodes and read the Y electrodes as the X electrodes.

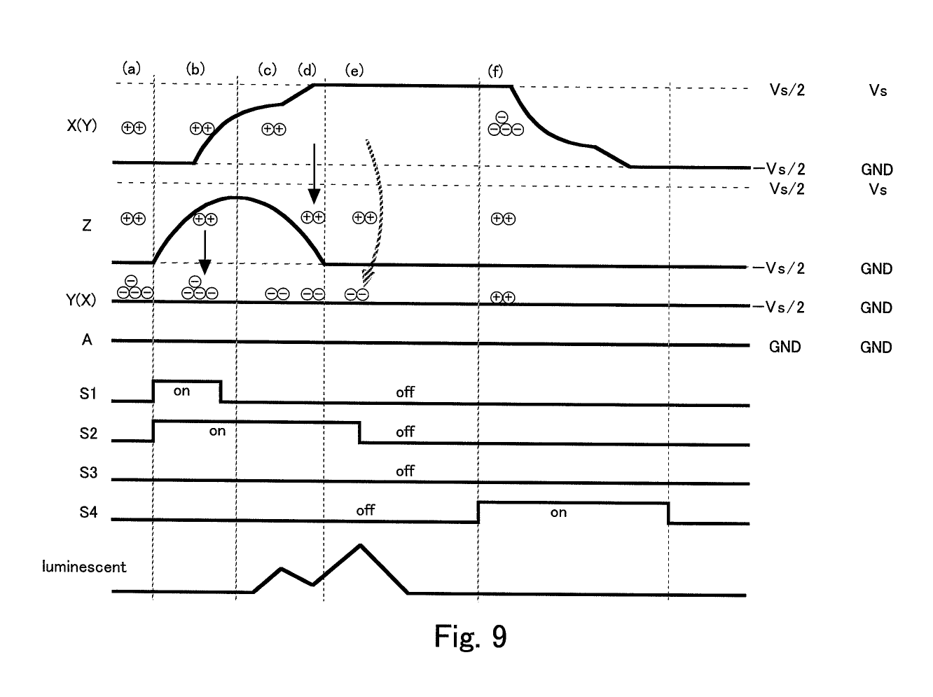

FIG. 9 illustrates operations in a sustain period Ts in a PDP studied by the present inventors. In the PDP in FIG. 9, a Z driver ZDRV has the structure of the circuit in FIG. 6 or FIG. 7 from which the switching circuit SW5 is removed. Therefore, the waveform of the Z electrodes is not kept at the voltage −Vs/2+α or GND+α but deceases to the initial voltage −Vs/2 or GND after the positive pulse is applied.

In FIG. 9, an amount of wall charges stored in the Z electrodes by the latest sustain discharge is relatively large (FIG. 9(a)). Since an amount of the wall charges in the Z electrodes is large, an amount of the wall charges moving between the Z electrodes and the Y electrodes when the voltage of the Z electrodes increases (FIG. 9(b)) is relatively large (solid arrow). Accordingly, a state immediately before the occurrence of the discharge (avalanche) cannot be maintained between the Z electrodes and the Y electrodes and relatively strong discharge (trigger discharge) occurs between the Z electrodes and the Y electrodes. By this discharge, an amount of positive wall charges in the Z electrodes and an amount of negative wall charges in the Y electrodes reduce.

Thereafter, the voltage of the X electrodes increases to Vs/2 (or Vs) and the voltage of the Z electrodes decreases to −Vs/2 (or GND (FIG. 9(d)). Since a voltage difference between the X electrodes and the Z electrodes is larger than that in FIG. 8, the low-efficiency short-distance discharge occurs (solid arrow). Due to the short-distance discharge, wall charges in the X electrodes move to the Z electrodes, and thus a ratio of the high-efficiency discharge (long-distance discharge) occurring between the X electrodes and the Y electrodes thereafter becomes lower (FIG. 9(e)).

In the first embodiment described above, during the long-distance discharge between the X electrodes and the Y electrodes, the voltage of the Z electrodes is set to the offset voltage −Vs/2+α which is higher than the low-level voltage −Vs/2 (initial voltage), and therefore, it possible to weaken the short-distance discharge between the X electrodes and the Z electrodes and to reduce an amount of the wall charges stored in the Z electrodes. As a result, a ratio of the high-efficiency long-distance discharge between the X electrodes and the Y electrodes can be increased, which can improve luminescent efficiency.

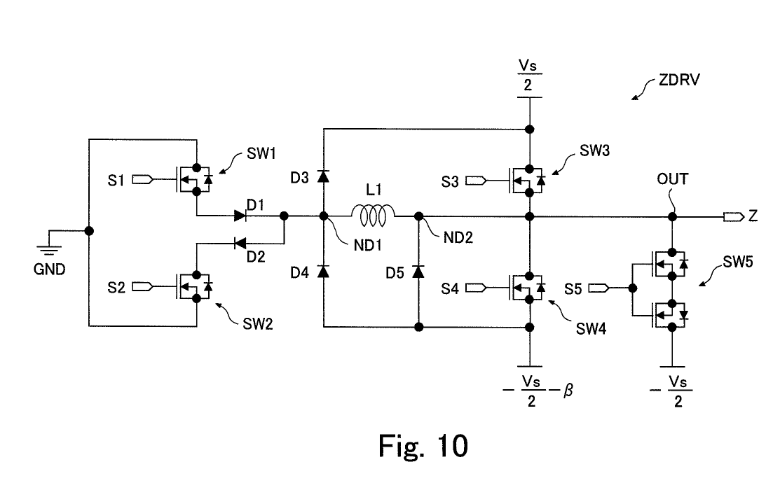

FIG. 10 illustrates details of a Z driver ZDRV in a second embodiment of the present invention. The structure except the Z driver ZDRV and a control circuit CNT (FIG. 1) controlling the operation of the Z driver ZDRV is the same as that of the first embodiment. The same reference numerals and symbols are used to designate the same elements as the elements described in the first embodiment, and detailed description thereof will be omitted.

In the Z driver ZDRV, a power source −VS/2−β (offset voltage line) is coupled to a source of a switching circuit SW4 (transistor), and a power source −VS/2 (initial voltage line) is coupled to a source of a switching circuit SW5 (transistor). The other structure of the Z driver ZDRV is the same as that of the first embodiment (FIG. 6).

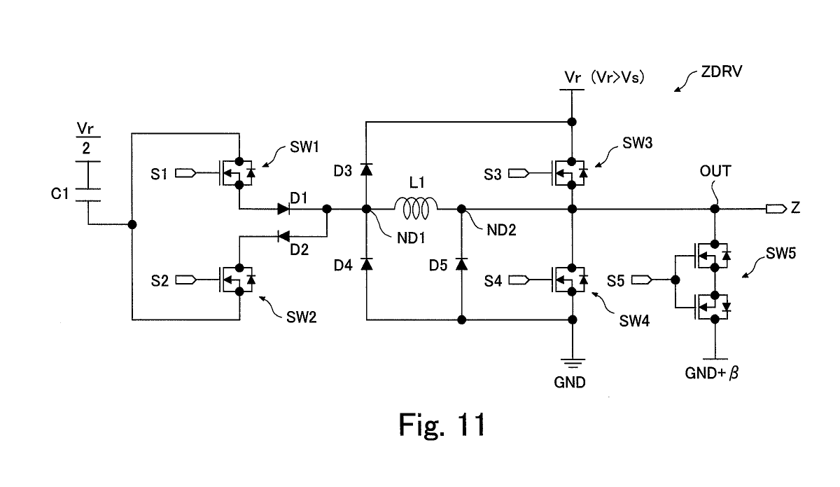

FIG. 11 illustrates another example of the Z driver ZDRV in the second embodiment. Its difference from the Z driver ZDRV illustrated in FIG. 10 lies in that a drain of a switching circuit SW1 and a source of a switching circuit SW2 are coupled to a power source Vr/2 via a capacitor C1. Further, a drain of a switching circuit SW3 is coupled to a power source Vr, a source of a switching circuit SW4 is coupled to a ground line GND (offset voltage line), and a source of a switching circuit SW5 is coupled to a power source GND+β (initial voltage line). A voltage of the power source Vr is higher than a voltage of the power source Vs. The other structure is the same as that in FIG. 10.

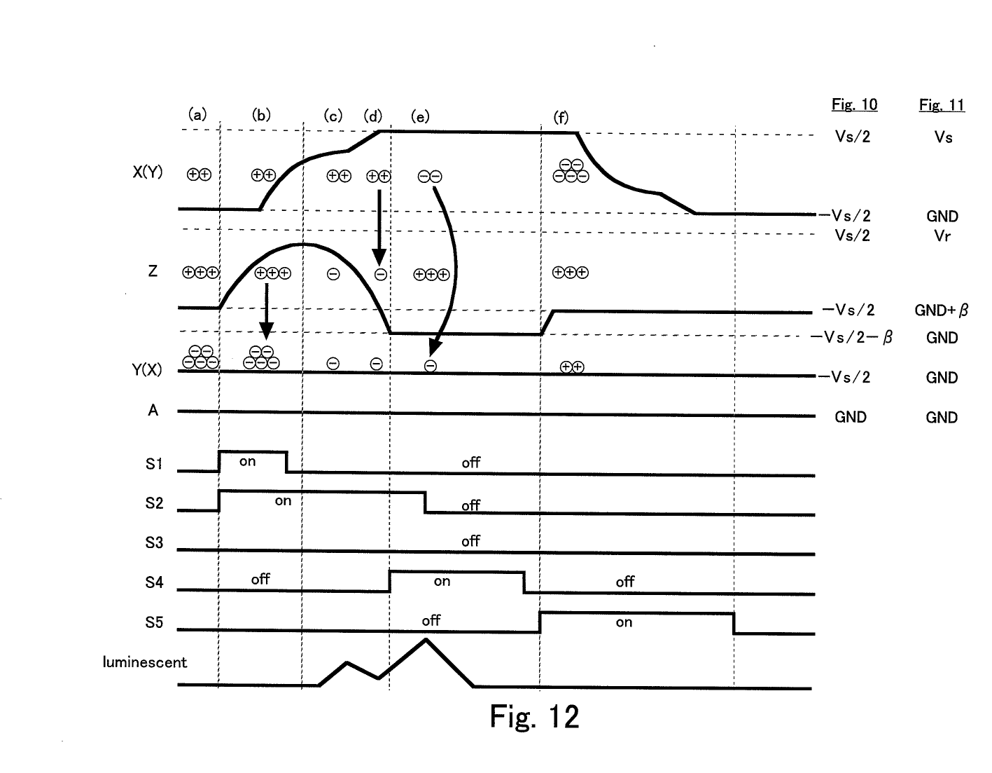

FIG. 12 illustrates operations in a sustain period Ts in a PDP of the second embodiment. Detailed description of the same operations as those in FIG. 8 described above will be omitted. The waveforms in FIG. 12 are those in the period, illustrated in FIG. 5, when the positive pulse is applied to the X electrodes, for instance. In the Z driver ZDRVZ illustrated in FIG. 10, a high-level voltage of the Z electrodes is slightly lower than Vs/2 and an initial value of a low-level voltage of the Z electrodes is −Vs/2. In the Z driver ZDRV illustrated in FIG. 11, a high-level voltage of the Z electrodes is slightly lower than Vr and an initial value of a low-level voltage of the Z electrodes is GND+β. The Z drivers ZDRV illustrated in FIG. 10 and FIG. 11 are different only in voltage amplitude. Therefore, the operation of the Z driver ZDRV illustrated in FIG. 10 will be described in the description below. An X driver XDRV and a Y driver YDRV have the structure of the Z driver ZDRV from which the switching circuit SW5 is removed, for instance.

First, by the latest sustain discharge, positive wall charges are stored in the X electrodes and the Z electrodes and negative wall charges are stored in the Y electrodes (FIG. 12(a)). At this time, an amount of the wall charges stored in the Z electrodes is relatively large. Voltages of the X electrodes, the Z electrodes, and the Y electrodes (initial values) are set to −Vs/2.

Next, the switching circuits SW1, SW2 turn on, and by the resonance operation of a coil L1, the voltage of the Z electrodes increases (FIG. 12(b)). Since an amount of the wall charges in the Z electrodes is large, discharge intensity between the Z electrodes and the Y electrodes increases, so that priming increases. As a result, an amount of the wall charges moving between the Z electrodes and the Y electrodes is relatively large (the thick arrow).

Next, the X driver XDRV operates to increase the voltage of the X electrodes (FIG. 12(c)). Thereafter, the voltage of the X electrodes increases to Vs/2. Further, the switching circuit SW4 turns on, so that the voltage of the Z electrodes decreases to −Vs/2−β (FIG. 12(d)). Consequently, a voltage difference between the X electrodes and the Z electrodes becomes larger, and the discharge between the X electrodes and the Z electrodes (short-distance discharge) becomes stronger (thick arrow). That is, the priming increases by the discharge between the X electrodes and the Z electrodes (short-distance discharge) as well.

Next, the voltage of the X electrodes increases to Vs/2 (FIG. 12(e)). Since the priming has increased by the short-distance discharge between the Z electrodes and the Y electrodes and the short-distance discharge between the X electrodes and the Z electrodes, high-efficiency long-distance discharge occurs between the X electrodes and the Y electrodes (thick arrow). Further, since the voltage of the Z electrodes is relatively low (−Vs/2−β), an amount of the wall charges stored in the Z electrodes becomes large.

After the long-distance discharge between the X electrodes and the Y electrodes is finished, the switching circuit SW4 turns off and the switching circuit SW5 turns on. Since the switching circuit SW5 turns on, the voltage of the Z electrodes increases to −VS/2 (initial voltage (FIG. 12(f)). By the long-distance discharge between the X electrodes and the Y electrodes, negative wall charges are stored in the X electrodes and positive wall charges are stored in the Y electrodes. Thereafter, the sustain discharge is caused in the same manner as in the above-described (a) to (f). However, since the polarities of the wall charges stored in the X electrodes and the Y electrodes become reversed, it is necessary to read the X electrodes as the Y electrodes and read the Y electrodes as the X electrodes.

The foregoing second embodiment can provide the same effects as those of the first embodiment described above. In addition, in this embodiment, during the long-distance discharge between the X electrodes and the Y electrodes, the voltage of the Z electrodes is set to the offset voltage −Vs/2−β which is lower than the low-level voltage −Vs/2 (initial voltage) (or is set to the offset voltage GND which is lower than the low-level voltage GND+β), and therefore, it is possible to make the short-distance discharge between the X electrodes and the Z electrodes stronger. Consequently, the priming can be increased. As a result, a ratio of the high-efficiency long-distance discharge between the X electrodes and the Y electrodes can be increased, which can improve luminescent efficiency. Especially because it is possible to increase an amount of the wall charges stored in the Z electrodes during the long-distance discharge between the X electrodes and the Y electrodes, it is possible to increase an amount of trigger discharge to increase the priming when the positive pulse is applied to the Z electrodes.

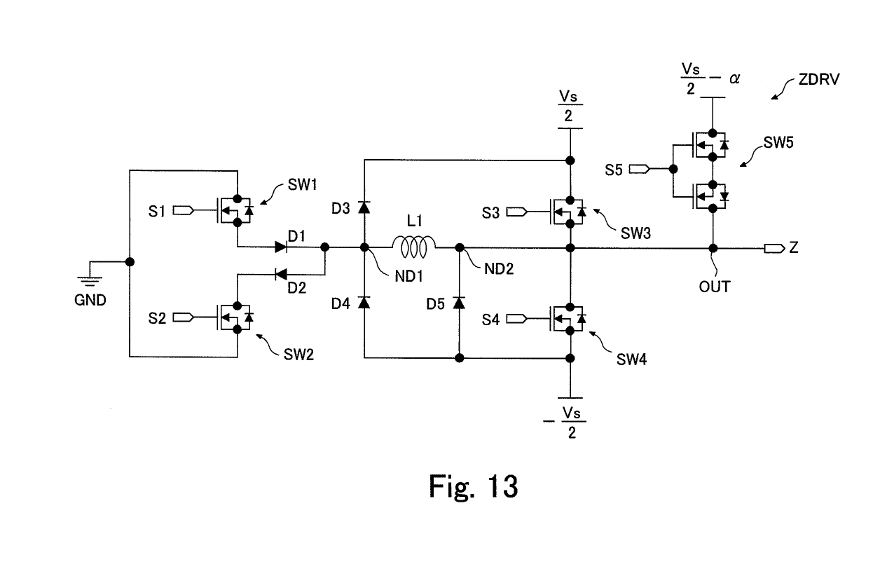

FIG. 13 illustrates details of a Z driver ZDRV in a third embodiment of the present invention. The structure except the Z driver ZDRV and a control circuit CNT (FIG. 1) controlling the operation of the Z driver ZDRV is the same as that of the first embodiment. The same reference numerals and symbols are used to designate the same elements as the elements described in the first embodiment, and detailed description thereof will be omitted.

In the Z driver ZDRV, a power source VS/2−α (offset voltage line) is coupled to a switching circuit SW5. The other structure of the Z driver ZDRV is the same as that of the first embodiment (FIG. 6).

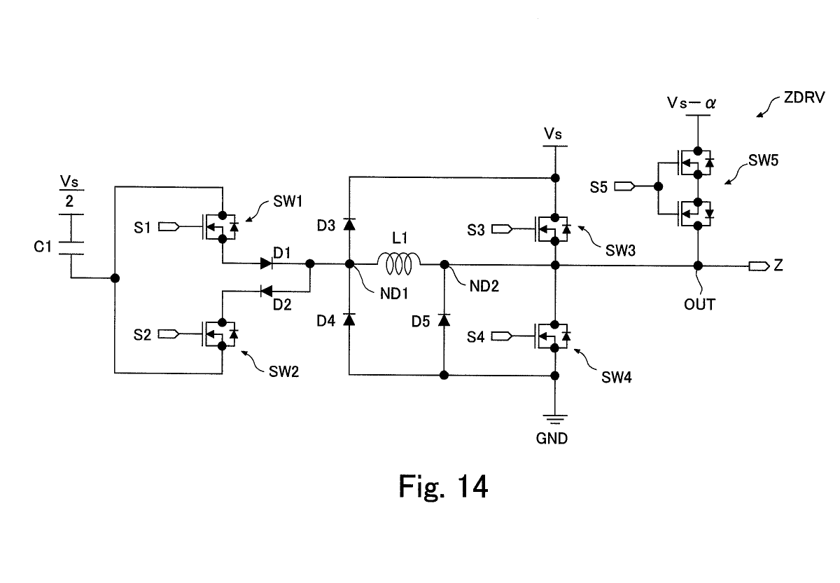

FIG. 14 illustrates another example of the Z driver ZDRV. This Z driver ZDRV is the same as the Z driver ZDRV illustrated in FIG. 7 except in that a power source Vs−α (offset voltage line) is coupled to a switching circuit SW5.

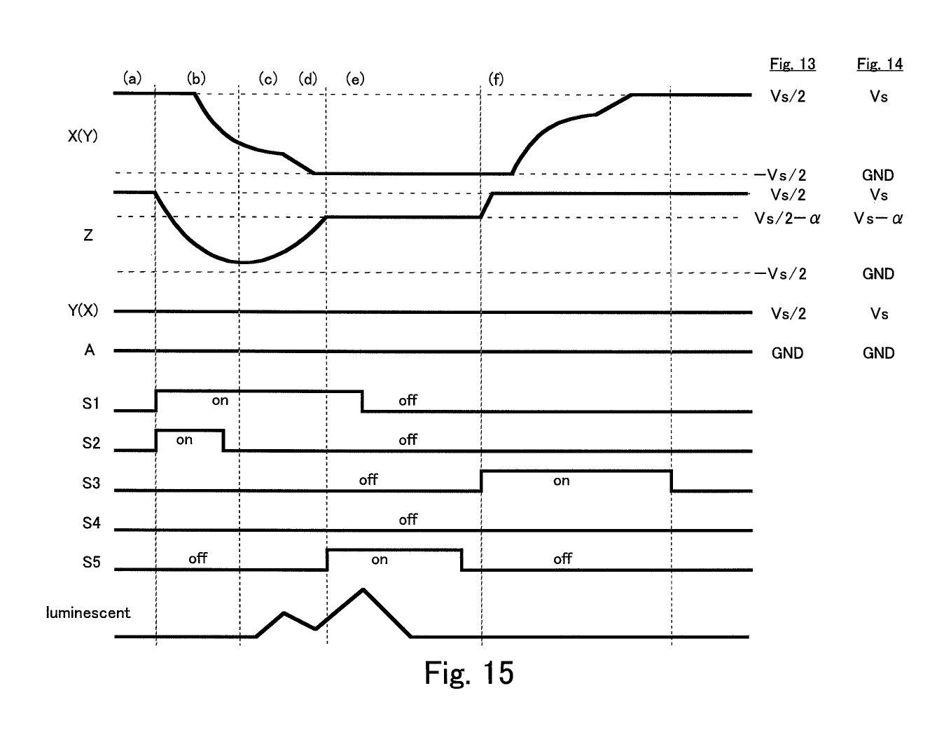

FIG. 15 illustrates operations in a sustain period Ts in a PDP of the third embodiment. Detailed description of the same operations as those of the first embodiment (FIG. 8) described above will be omitted. The Z drivers ZDRV illustrated in FIG. 13 and FIG. 14 are different only in voltage amplitude. Therefore, the operation of the Z driver ZDRV illustrated in FIG. 14 will be described in the following description. In this embodiment, in the sustain period Ts, negative pulses are applied to the X electrodes (or the Y electrodes) and the Z electrodes. Therefore, waveforms of switch control signals S1, S2 are interchanged compared with those in FIG. 8. Waveforms of switch control signals S3, S4 are interchanged compared with those in FIG. 8. The Z electrodes, after the negative pulse is applied thereto, is kept at a voltage Vs/2−α (offset voltage) which is lower than an initial voltage Vs/2, and after the end of sustain discharge, is returned to the initial voltage Vs/2. That is, the voltage of the Z electrodes is set to a value between the high-level voltage Vs/2 and a low-level voltage −Vs/2 applied to the X electrodes and the Y electrodes.

The foregoing third embodiment can provide the same effects as those of the first embodiment described above. That is, by setting the voltage of the Z electrodes lower than the high-level voltage Vs/2 (initial voltage) during long-distance discharge between the X electrodes and the Y electrodes, it is possible to weaken short-distance discharge between the X electrodes and the Z electrodes and reduce an amount of wall charges stored in the Z electrodes. As a result, it is possible to increase a ratio of the high-efficiency long-distance discharge between the X electrodes and the Y electrodes, which can improve luminescent efficiency.

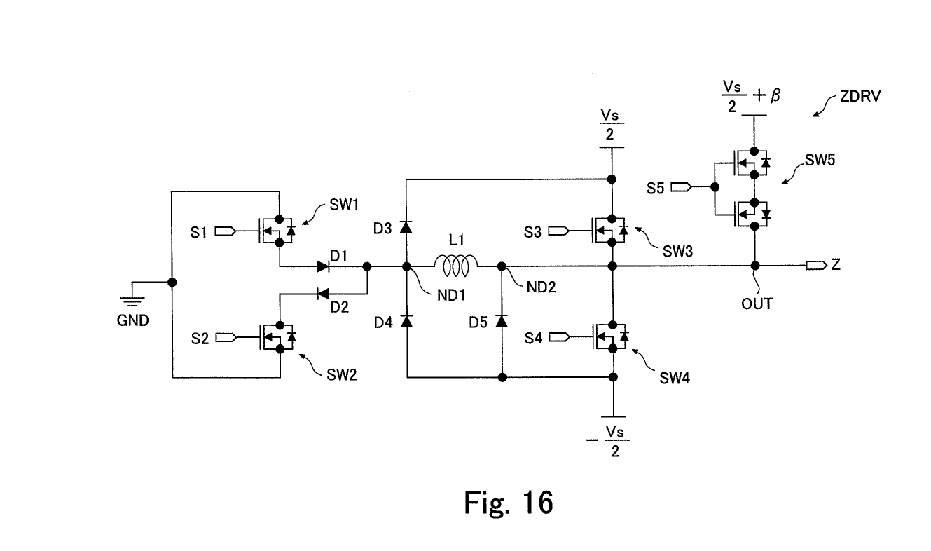

FIG. 16 illustrates details of a Z driver ZDRV in a fourth embodiment of the present invention. The structure except the Z driver ZDRV and a control circuit CNT (FIG. 1) controlling the operation of the Z driver ZDRV is the same as that of the first embodiment. The same reference numerals and symbols are used to designate the same elements as the elements described in the first embodiment, and detailed description thereof will be omitted.

In the Z driver ZDRV, a power source VS/2+β (offset voltage line) is coupled to a switching circuit SW5. The other structure of the Z driver ZDRV is the same as that of the first embodiment (FIG. 6).

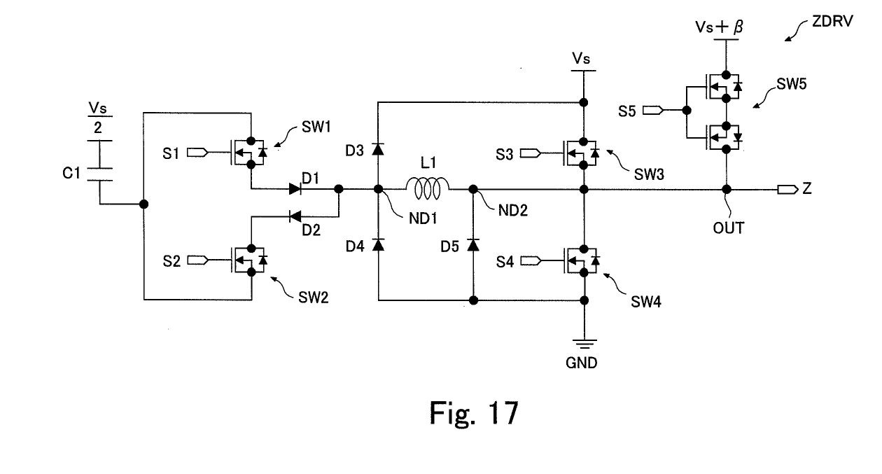

FIG. 17 illustrates another example of the Z driver ZDRV. The Z driver ZDRV is the same as the Z driver ZDRV illustrated in FIG. 7 except in that a power source VS+β (offset voltage line) is coupled to a switching circuit SW5.

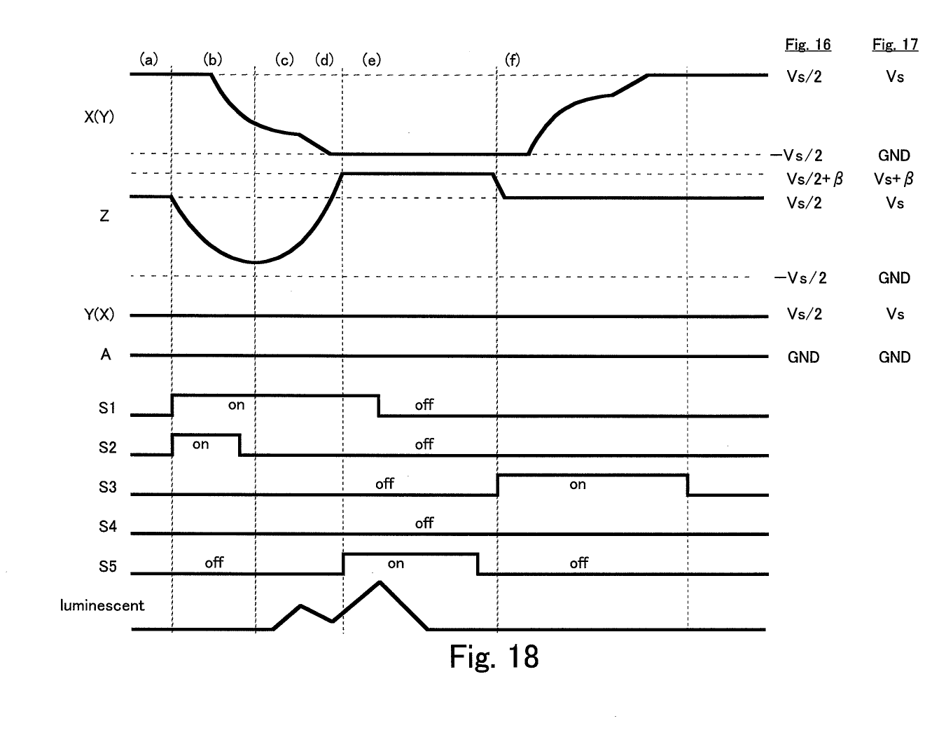

FIG. 18 illustrates operations during a sustain period Ts in a PDP of the fourth embodiment. Detailed description of the same operations as those of the above-described second embodiment (FIG. 12) will be omitted. The Z drivers ZDRV illustrated in FIG. 16 and FIG. 17 are different only in voltage amplitude. Therefore, the operation of the Z driver ZDRV illustrated in FIG. 16 will be described in the description below. In this embodiment, as in the third embodiment (FIG. 15), a negative pulse is applied to the X electrodes (or the Y electrodes) and the Z electrodes in the sustain period Ts. Therefore, waveforms of switch control signals S1, S2 are interchanged compared with those in FIG. 12. Waveforms of switch control signals S3, S4 are interchanged compared with those in FIG. 12. The Z electrodes, after the negative pulse is applied thereto, is kept at a voltage Vs/2+β (offset voltage) which is higher than an initial voltage Vs/2, and is returned to the initial voltage Vs/2 after the sustain discharge is finished. That is, the voltage of the Z electrodes is set to a value higher than the high-level voltage Vs/2 applied to the X electrodes and the Y electrodes.

The foregoing fourth embodiment can provide the same effects as those of the first and second embodiments described above. That is, by setting the voltage of the Z electrodes higher than the high-level voltage Vs/2 (initial voltage) during long-distance discharge between the X electrodes and the Y electrodes, it is possible to make short-distance discharge between the X electrodes and the Z electrodes stronger. Consequently, priming can be increased. As a result, a ratio of the high-efficiency long-distance discharge between the X electrodes and the Y electrodes can be increased, which can improve luminescent efficiency. Especially because it is possible to increase an amount of wall charges stored in the Z electrodes during the long-distance discharge between the X electrodes and the Y electrodes, it is possible to increase an amount of trigger discharge when the negative pulse is applied to the Z electrodes, which can increase the priming.

Incidentally, the above embodiments describe the examples where the Z driver ZDRV includes a resonance circuit and the resonance pulse is applied to the Z electrodes. The present invention is not limited to such embodiments. For example, a rectangular pulse may be applied to the Z electrodes as shown in FIG. 5.

The above embodiments describe the examples where the present invention is applied to the plasma display panel of the ALIS method. The present invention is not limited to such embodiments. For example, the present invention may be applied to a plasma display panel in which discharge gaps for emitting light by the discharge are provided only in one of the X electrode side and the Y electrode side.

Hitherto, the present invention has been described in detail, but the above-described embodiments and modification examples thereof are only examples of the present invention, and the present invention is not limited thereto. It is obvious that changes can be made within a range not departing from the present invention.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to exact construction and operation illustrated and described, and accordingly all suitable modifications and equivalents may be resorted to, falling within the scope thereof.

1. A plasma display device, comprising:
a plasma display panel; and
a driving unit driving the plasma display panel, wherein
the plasma display panel comprises:
a first and a second plate facing each other via a discharge space;
a first and a second electrode disposed on the first plate to be parallel to each other;
a third electrode disposed on the second plate to extend in a direction perpendicular to the first and second electrodes;
a fourth electrode disposed on the first plate to be positioned between the first and second electrodes; and
discharge cells formed at positions where the first, second, and fourth electrodes intersect with the third electrode, wherein
the driving unit comprises:
a first driving circuit alternately reversing polarities of voltages applied to the first and second electrodes in order to cause sustain discharge between the first and second electrodes;
a second driving circuit which applies a pulse to the fourth electrode in synchronization with a timing when the polarities of the voltages to the first and second electrodes are reversed, and during the sustain discharge between the first and second electrodes, keeps a voltage of the fourth electrode after the application of the pulse at an offset voltage deviated by a predetermined value from an initial voltage that the fourth electrode has before the generation of the pulse, and thereafter returns the voltage of the fourth electrode to the initial voltage; and
a third driving circuit applying a selection pulse to the third electrode in order to select the discharge cell which is to emit light by the discharge.

2. The plasma display device according to claim 1, wherein
the offset voltage is set to a value between a high-level voltage and a low-level voltage to be applied to the first and second electrodes during the sustain discharge.

3. The plasma display device according to claim 1, wherein
the offset voltage is set to a value lower than a low-level voltage to be applied to one of the first and second electrodes during the sustain discharge.

4. The plasma display device according to claim 1, wherein
the offset voltage is set to a value higher than a high-level voltage to be applied to one of the first and second electrodes during the sustain discharge.

5. The plasma display device according to any one of claim 2 to claim 4, wherein
the second driving circuit comprises:
a resonance circuit generating a resonance pulse applied to the fourth electrode; and
a switching circuit coupling the fourth electrode to an offset voltage line through which the offset voltage is supplied, in synchronization with a timing when a trailing edge of the resonance pulse is generated.

6. The plasma display device according to claim 1, wherein
discharge gaps for emitting light by the discharge are provided on both sides of the first and second electrodes.

7. A method of driving a plasma display panel which includes: a first and a second plate facing each other via a discharge space; a first and a second electrode disposed on the first plate to be parallel to each other; a third electrode disposed on the second plate to extend in a direction perpendicular to the first and second electrodes; and a fourth electrode disposed on the first plate to be positioned between the first and second electrodes, and in which discharge cells are formed at positions where the first, second, and fourth electrodes intersect with the third electrode, the method comprising:
applying a selection pulse to the third electrode in order to select the discharge cell which is to emit light by the discharge;
alternately reversing polarities of voltages applied to the first and second electrodes in order to cause sustain discharge between the first and second electrodes; and
applying a pulse to the fourth electrode in synchronization with a timing when the polarities of the voltages to the first and second electrodes are reversed, keeping a trailing edge of the pulse at an offset voltage which is deviated by a predetermined value from an initial voltage that the fourth electrode has before the generation of the pulse, during the sustain discharge between the first and the second electrodes, and thereafter returning the trailing edge to the initial voltage.

8. The method of driving the plasma display panel according to claim 7, wherein
the offset voltage is set to a value between a high-level voltage and a low-level voltage to be applied to the first and second electrodes during the sustain discharge.

9. The method of driving the plasma display panel according to claim 7, wherein
the offset voltage is set to a value lower than a low-level voltage to be applied to one of the first and second electrodes during the sustain discharge.

10. The method of driving the plasma display panel according to claim 7, wherein
the offset voltage is set to a value higher than a high-level voltage to be applied to one of the first and second electrodes during the sustain discharge.
